(19) United States
(12) Patent Application Publication
(10) Pub. No.: US 2025/0069790 A1
(43) Pub. Date: Feb. 27, 2025

(54) COIL COMPONENT

(71) Applicant: SAMSUNG ELECTRO-MECHANICS CO., LTD., Suwon-si (KR)

(72) Inventors: Boum Seock KIM, Suwon-si (KR); Byeong Cheol MOON, Suwon-si (KR); Sang Jin KIM, Suwon-si (KR); Ju Hyoung PARK, Suwon-si (KR)

(73) Assignee: SAMSUNG ELECTRO-MECHANICS CO., LTD., Suwon-si (KR)

(21) Appl. No.: 18/633,825

(22) Filed: Apr. 12, 2024

(30) Foreign Application Priority Data
Aug. 21, 2023 (KR) 10-2023-0108765

(51) Int. Cl. H01F 5/04; H01F 27/29; H01F 27/30; H01F 27/32

(52) U.S. Cl. CPC H01F 5/04; H01F 27/306; H01F 27/324; H01F 27/292

(57) ABSTRACT

A coil component, may include: a body having a first surface and a second surface facing each other in a first direction; a support member disposed within the body; a coil disposed on the support member; an external electrode disposed on the first surface of the body; and a connection portion disposed within the body to connect the coil and the external electrode, the connection portion having one surface in contact with the coil and another surface in contact with the external electrode, in which the connection portion may include a fused portion formed at an end in contact with the coil.

### CROSS-REFERENCE TO RELATED APPLICATION(S)

This application claims benefit of priority to Korean Patent Application No. 10-2023-0108765 filed on Aug. 21, 2023 in the Korean Intellectual Property Office, the disclosure of which is incorporated herein by reference in its entirety.

### TECHNICAL FIELD The present disclosure relates to a coil component.

### BACKGROUND

An inductor, a coil component, is a representative passive electronic component used in electronic devices along with resistors and capacitors.

As electronic devices are increasingly implemented with high-performance and are miniaturized, electronic components used in electronic devices are also increasing in number and becoming smaller.

Meanwhile, it may be advantageous for the miniaturization and integration of coil components to dispose an external electrode on a lower surface of a body, a surface on which coil components are mounted on a printed circuit board (PCB), but in the case of a bottom electrode structure, in which an external electrode is disposed on the lower surface of the body and a volume of a magnetic material in the coil component may be maximized, and which is advantageous for the manufacturing process, may be required.

### SUMMARY

An aspect of the present disclosure is to improve inductance characteristics and saturated current (Iₛₐₜ) characteristics by maximizing an effective volume within a coil component of a limited size through a structure in which a coil and an external electrode are connected inside a body.

Another aspect of the present disclosure is to obtain process advantages such as preventing defective connection between a coil and an external electrode, preventing plating defects of the external electrode from spreading, or the like, through a process of forming a connection portion, formed by connecting the coil and the external electrode and an external electrode in advance and then bonding the same to the coil.

According to an aspect of the present disclosure, a coil component may be provided, the coil component including: a body having a first surface and a second surface facing each other in a first direction; a support member disposed within the body; a coil disposed on the support member; an external electrode disposed on the first surface of the body; and a connection portion disposed within the body to connect the coil and the external electrode, the connection portion having one surface in contact with the coil and another surface in contact with the external electrode, in which the connection portion may include a fused portion formed at an end in contact with the coil.

### BRIEF DESCRIPTION OF DRAWINGS

The above and other aspects, features, and advantages of the present

disclosure will be more clearly understood from the following detailed description, taken in conjunction with the accompanying drawings, in which:

FIG. 1 is a perspective view schematically illustrating a coil component according to a first embodiment of the present disclosure;

FIG. 2 is an exploded perspective view of FIG. 1;

FIG. 3 is a diagram illustrating a cross-section taken along line I-I′ of FIG. 1;

FIG. 4 is an enlarged view of region A of FIG. 3;

FIG. 5 is a diagram illustrating a cross-section taken along line II-II′ in FIG. 1;

FIGS. 6, 7 and 8 are views schematically illustrating a manufacturing process of a coil component according to a first embodiment of the present disclosure;

FIG. 9 is a diagram schematically illustrating a coil component according to a second embodiment of the present disclosure, corresponding to FIG. 3; and

FIGS. 10, 11 and 12 are views schematically illustrating a manufacturing process of a coil component according to a second embodiment of the present disclosure.

### DETAILED DESCRIPTION

The terms used in the present application are only used to describe specific embodiments, and are not intended to limit the present disclosure. The singular expression includes the plural expression unless the context clearly dictates otherwise. In the present application, terms such as “comprise” or “have” are intended to designate that a feature, number, step, operation, component, part, or combination thereof described in the specification exists, and it should be understood that this does not preclude the possibility of addition or existence of one or more other features or numbers, steps, operations, components, parts, or combinations thereof. Throughout the specification, “on” means to be positioned above or below the target part, and does not necessarily mean to be positioned on the upper side with respect to the direction of gravity.

In addition, the term “coupling” does not mean only a case of direct physical contact between respective components in the contact relationship between respective components, and is used as a concept that encompasses even the case in which other components are interposed between respective components and the components are respectively in contact with the other components.

The size and thickness of each component illustrated in the drawings are arbitrarily indicated for convenience of description, and thus, the present disclosure is not necessarily limited to the illustration.

In the drawings, a T direction may be defined as a first direction or a thickness direction, an L direction may be defined as a second direction or a length direction, and a W direction may be defined as a third direction or a width direction.

Hereinafter, a coil component according to an embodiment will be described in detail with reference to the accompanying drawings, and in the description with reference to the accompanying drawings, the same or corresponding components are given the same reference numerals, and the overlapping description thereof will be omitted.

Various types of electronic components are used in electronic devices, and among these electronic components, various types of coil components may be appropriately used for noise removal and the like.

For example, in electronic devices, the coil component may be used as a power inductor, a high frequency (HF) inductor, a general bead, a high frequency bead (GHz Bead), a common mode filter, or the like.

### First Embodiment

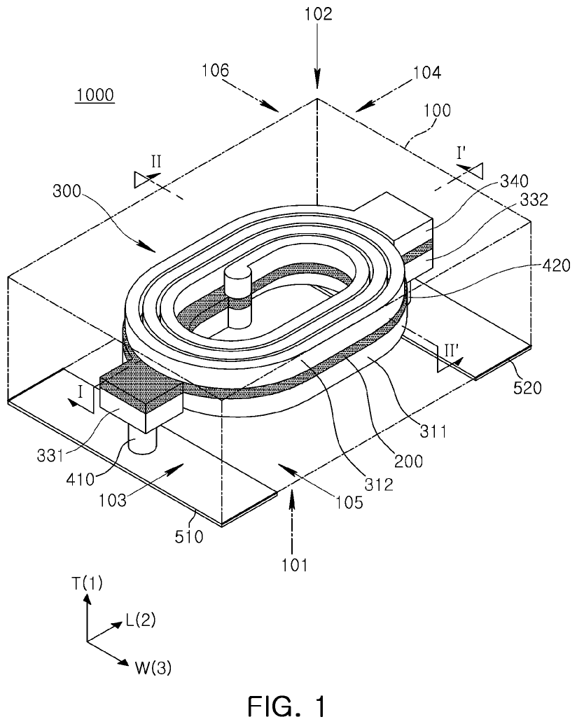

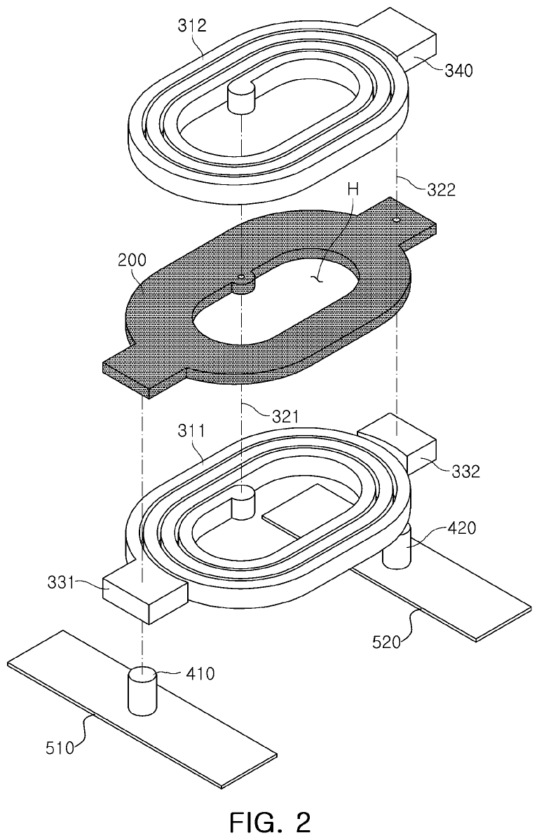

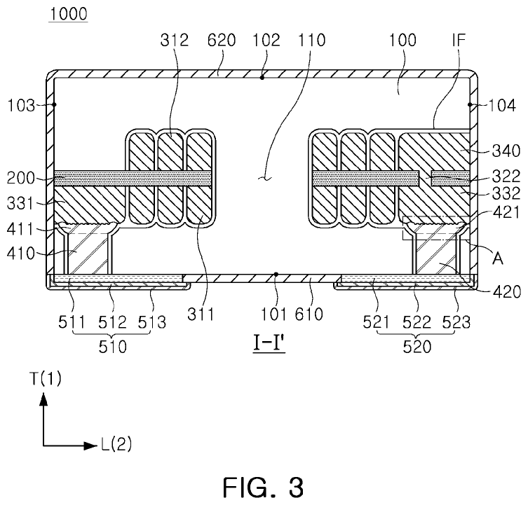

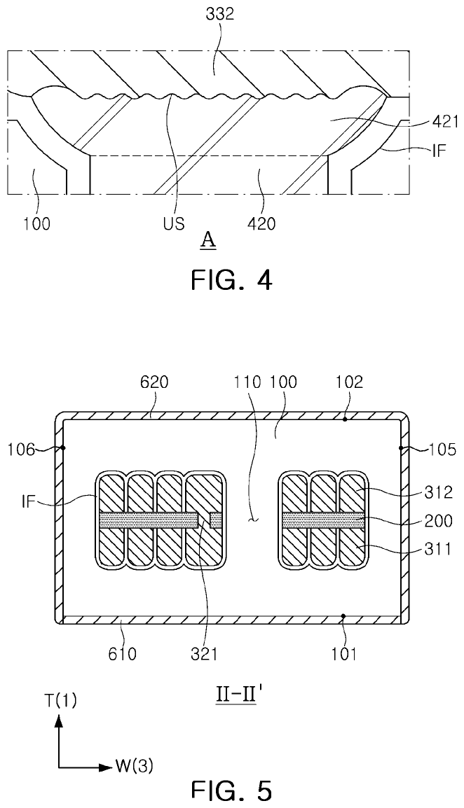

FIG. 1 is a perspective view schematically illustrating a coil component 1000 according to a first embodiment of the present disclosure. FIG. 2 is an exploded perspective view of FIG. 1. FIG. 3 is a diagram illustrating a cross-section taken along line I-I′ of FIG. 1. FIG. 4 is an enlarged view of region A of FIG. 3. FIG. 5 is a diagram illustrating a cross-section taken along line II-II′ in FIG. 1.

Meanwhile, in FIG. 1, in order to more clearly illustrate the coupling between components, a first insulating layer 610 and a second insulating layer 620 on a body 100 that can be applied to the present embodiment are omitted and illustrated.

The coil component 1000 according to the present embodiment may include connection portions 410 and 420 respectively connecting a coil 300 and external electrodes 510 and 520 within the body 100, and the connection portions 410 and 420 may be formed on a detach core DC in advance and then fused with the coil 300, and magnetic sheets may be laminated to form the body 100.

The coil component 1000 according to the present embodiment may have a bottom electrode structure in which the external electrodes 510 and 520 are disposed on a lower surface of the body 100, that is, a first surface 101 thereof, so that due to an increase in an effective volume of the coil component 1000, inductance characteristics may be improved and saturated current characteristics (Iₛₐₜ) may also be improved.

In addition, a process for implementing the bottom electrode may be simpler than the existing process, and compared to a case in which the connection portions 410 and 420 are formed by plating from the coil 300 toward the external electrodes 510 and 520, it may be easy to perform height control of the connection portions 410 and 420.

In addition, as compared to a case in which a via hole is processed to the coil 300 after forming the body 100 and the connection portions 410 and 420 are formed by plating, a process in which the via hole is processed may be omitted, and as the connection portions 410 and 420 are formed by plating, defects such as clogging inside the via hole may be prevented.

In addition, since it has a structure in which fused portions 411 and 421 are formed by welding between the coil 300 and the connection portions 410 and 420, physical bonding force or reliability of the connection between the coil 300 and the connection portions 410 and 420 may be improved.

Hereinafter, the main components constituting the coil component 1000 according to the present embodiment will be described in detail.

Referring to FIGS. 1 to 5, the coil component 1000 according to a first embodiment of the present disclosure may include a body 100, a support member 200, a coil 300, external electrodes 510 and 520, and connection portions 410 and 420 respectively connecting the coil 300 and the external electrodes 510 and 520.

The body 100 forms the exterior of the coil component 1000 according to the present embodiment, and the coil 300 may be disposed therein. The coil 300 may be supported by a support member 200, but the present disclosure is not limited thereto, and the coil component 1000 according to the present embodiment may also have a coreless structure in which the support member 200 is omitted.

The body 100 may be formed to have an overall hexahedral shape.

Based on the direction of FIG. 1, the body 100 includes a first surface 101 and a second surface 102 facing each other in a thickness direction (T), a third surface 103 and a fourth surface 104 facing each other in a length direction (L), and a fifth surface 105 and a sixth surface 106 facing each other in a width direction (W). Each of the third to six surfaces 103, 104, 105, and 106 of the body 100 corresponds to a wall surface of the body 100 connecting the first surface 101 and the second surface 102 of the body 100.

In the body 100, as an example, the coil component 1000 according to the present embodiment in which the external electrodes 510 and 520 are formed may be formed to have a length of 2.5 mm, a width of 2.0 mm, and a thickness of 0.8 mm, to have a length of 2.0 mm, a width of 1.2 mm and a thickness of 0.6 mm, to have a length of 1.6 mm, a width of 0.8 mm, and a thickness of 0.6 mm, to have a length of 1.6 mm, a width of 0.8 mm and a thickness of 0.4 mm, to have a length of 1.4 mm, a width of 1.2 mm, and a thickness of 0.65 mm, or to have a length of 1.0 mm, a width of 0.7 mm, and a thickness of 0.65 mm, or to have a length of 0.8 mm, a width of 0.4 mm, and a thickness of 0.65 mm, or to have a length of 0.8 mm, a width of 0.4 mm, and a thickness of 0.5 mm, but the present disclosure is not limited thereto. On the other hand, the above-described exemplary values for the length, width, and thickness of the coil component 1000 refer to values that do not reflect process errors, and the values within the range that may be recognized as process errors should be considered to correspond to the above-described exemplary values.

Based on the optical microscope image or Scanning Electron Microscope (SEM) image of a length direction (L)-thickness direction (T) cross-section taken from a central portion of the coil component 1000 in a width direction (W), the length of the coil component 1000 described above may refer to a maximum value of dimensions of a plurality of respective line segments obtained by respectively connecting two outermost boundary lines of the coil component 1000, facing in the length direction (L) of the coil component 1000 illustrated in the cross-sectional image, to each other to be parallel to the length direction (L). Alternatively, the length of the coil component 1000 may refer to a minimum value among the dimensions of the plurality of respective line segments obtained by respectively connecting two outermost boundary lines of the coil component 1000, facing in the length direction (L) of the coil component 1000 illustrated in the cross-sectional image, to each other to be parallel to the length direction (L). Alternatively, the length of the coil component 1000 may refer to an arithmetic mean value of at least three or more of the dimensions of the plurality of respective line segments obtained by respectively connecting two outermost boundary lines of the coil component 1000, facing in the length direction (L) of the coil component 1000 illustrated in the cross-sectional image, to each other to be parallel to the length direction (L). In this case, the plurality of line segments parallel to the length direction (L) may be equally spaced from each other in the thickness direction (T), but the scope of the present disclosure is not limited thereto.

Based on the optical microscope image or Scanning Electron Microscope (SEM) image of the length direction (L)-thickness direction (T) cross-section taken from the central portion of the coil component 1000 in the width direction (W), the thickness of the coil component 1000 described above may refer to a maximum value of dimensions of a plurality of respective line segments obtained by respectively connecting two outermost boundary lines of the coil component 1000, facing in the thickness direction (T) illustrated in the cross-sectional image, to each other to be parallel to the thickness direction (T). Alternatively, the thickness of the coil component 1000 may refer to a minimum value among the dimensions of the plurality of respective line segments obtained by respectively connecting two outermost boundary lines of the coil component 1000, facing in the thickness direction (T) illustrated in the cross-sectional image, to each other to be parallel to the thickness direction (T). Alternatively, the thickness of the coil component 1000 may refer to an arithmetic mean value of at least three or more of the dimensions of the plurality of respective line segments obtained by respectively connecting two outermost boundary lines of the coil component 1000, facing in the thickness direction (T) illustrated in the cross-sectional image, to each other to be parallel to the thickness direction (T). In this case, the plurality of line segments parallel to the thickness direction (T) may be equally spaced from each other in the length direction (L), but the scope of the present disclosure is not limited thereto.

Based on the optical microscope image or Scanning Electron Microscope (SEM) image of the length direction (L)-width direction (W) cross-section taken from the central portion of the coil component 1000 in the thickness direction (T), the width of the coil component 1000 described above may refer to a maximum value among dimensions of a plurality of respective line segments obtained by respectively connecting two outermost boundary lines of the coil component 1000, facing in the width direction (W), illustrated in the cross-sectional image, to each other to be parallel to the width direction (W). Alternatively, the width of the coil component 1000 may refer to a minimum value among the dimensions of the plurality of respective line segments obtained by respectively connecting two outermost boundary lines of the coil component 1000, facing in the width direction (W). Alternatively, the width of the coil component 1000 may refer to an arithmetic mean value of at least three or more of the dimensions of the plurality of respective line segments obtained by respectively connecting two outermost boundary lines of the coil component 1000, facing in the width direction (W). In this case, the plurality of line segments parallel to the width direction (W) may be equally spaced from each other in the length direction (L), but the scope of the present disclosure is not limited thereto.

Alternatively, each of the length, width, and thickness of the coil component 1000 may be measured by a micrometer measurement method. The micrometer measurement method may be performed by setting the zero point with a gage Repeatability and Reproducibility (R&R) micrometer, inserting the coil component 1000 according to this embodiment between the tips of the micrometer and turning the measuring lever of the micrometer. On the other hand, in measuring the length of the coil component 1000 by the micrometer measurement method, the length of the coil component 1000 may refer to a value measured once, and may also refer to an arithmetic mean of values measured multiple times. This may equally be applied to the width and thickness of the coil component 1000.

The body 100 may include an insulating resin and a magnetic material. In detail, the body 100 may be formed by laminating one or more magnetic composite sheets in which a magnetic material is dispersed in a resin. The magnetic material may be ferrite or magnetic metal powder.

Ferrite may be at least one of, for example, spinel-type ferrites such as Mg—Zn, Mn—Zn, Mn—Mg, Cu—Zn, Mg—Mn—Sr, Ni—Zn, and the like, hexagonal ferrites such as Ba—Zn, Ba—Mg, Ba—Ni, Ba—Co, and Ba—Ni—Co, and the like, garnet-type ferrites such as Y and the like, and Li ferrites.

The magnetic metal powder may include any one or more selected from the group consisting of iron (Fe), silicon (Si), chromium (Cr), cobalt (Co), molybdenum (Mo), aluminum (Al), niobium (Nb), copper (Cu), boron (B), zirconium (Zr), hafnium (Hf), phosphorus (P), and nickel (Ni). For example, the magnetic metal powder may be at least one of pure iron powder, Fe—Si alloy powder, Fe—Si—Al alloy powder, Fe—Ni alloy powder,

Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder.

The magnetic metal powder may include amorphous and/or crystalline. For example, the magnetic metal powder may be an Fe—Si—B—Cr-based amorphous alloy powder, but is not necessarily limited thereto. The ferrite and magnetic metal powder may have an average diameter of about 0.1 μm to 30 μm, but the present disclosure is not limited thereto.

The body 100 may include two or more types of magnetic materials dispersed in a resin. In this case, the different types of magnetic materials mean that the magnetic materials dispersed in the resin are distinguished from each other by any one of an average diameter, composition, crystallinity, and shape.

Meanwhile, the following description will be made on the premise that the magnetic material is magnetic metal powder, but the scope of the present disclosure does not extend only to the body 100 having a structure in which magnetic metal powder is dispersed in an insulating resin.

The insulating resin may include, but is not limited to, epoxy, polyimide, a liquid crystal polymer, or the like, alone or in combination.

Referring to FIGS. 3 and 4, the body 100 includes a core 110 penetrating the support member 200 and the coil 300. The core 110 may be disposed in a central region of an innermost turn of the coil 300, that is, in a central region of the turns of the coil 300.

Referring to FIGS. 3 and 4, the body 100 includes a core 110 penetrating the support member 200 and the coil 300. The core 110 may be disposed in a central region of an innermost turn of the coil 300, that is, in a central winding region of the coil 300.

Referring to FIGS. 1 and 2, the core 110 may be formed by filling a through-hole H penetrating a center of the coil 300 and a center of the support member 200 with a magnetic composite sheet containing a magnetic material, but the present disclosure is not limited thereto.

The support member 200 may be disposed inside the body 100, and may have one surface and the other surface facing each other. The support member 200 is a component to support the coil 300.

Referring to FIGS. 2 and 3, the central portion of the support member 200 may be removed through a trimming process to form a through-hole H, and a core 110 may be disposed in the through-hole H. Here, the through-hole H formed on the support member 200 may be formed in a shape corresponding to a shape of the innermost turn of the coil 300.

The support member 200 may be formed of an insulating material including a thermosetting insulating resin such as an epoxy resin, a thermoplastic insulating resin such as polyimide, or a photosensitive insulating resin, or may be formed of an insulating material impregnated with a reinforcing material such as glass fiber or an inorganic filler in this insulating resin. For example, the support member 200 may include a Prepreg, Ajinomoto Build-up Film (ABF), FR-4, Bismaleimide Triazine (BT) resin, Photo Imageable Dielectric (PID), and the like, but the present disclosure is not limited thereto.

As an inorganic filler, at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the support member 200 is formed of an insulating material including a reinforcing material, the support member 200 may provide more excellent rigidity. When the support member 200 is formed of an insulating material that does not contain glass fibers, it may be advantageous to reduce the thickness of the coil component 1000 according to an embodiment of the present disclosure. In addition, based on the body 100 having the same size, a volume occupied by the coil 300 and/or the magnetic metal powder may be increased, thereby improving component characteristics. When the support member 200 is formed of an insulating material including a photosensitive insulating resin, since the number of processes for forming the coil 300 is reduced, it may be advantageous to reduce production costs, and vias 321 and 322 may be finely formed.

The thickness of the support member 200 may be, for example, 10 μm or more and 50 μm or less, but is not limited thereto.

The coil 300 is disposed inside the body 100 and exhibits the characteristics of a coil component 1000. For example, when the coil component 1000 according to the present embodiment is used as a power inductor, the coil 300 stores the electric field as a magnetic field to maintain an output voltage, thereby stabilizing the power of an electronic device.

The coil component 1000 according to the present embodiment may include a coil 300 disposed inside the body 100 and supported by the support member 200. The coil 300 may include at least one turn wound around the core 110.

Referring to FIGS. 1 to 5, the coil 300 of the present embodiment may include first and second coil portions 311 and 312, a first via 321, first and second lead-out portions 331 and 332, a sub lead-out portion 340, and a second via 322.

In detail, a first coil portion 311, a first lead-out portion 331 extending from the first coil portion 311, and a second lead-out portion 332, spaced apart from the first coil portion 311 may be disposed on one surface of the support member 200 facing the first surface 101 of the body 100, and a second coil portion 312 and a sub lead-out portion 340 extending from the second coil portion 312 may be disposed on the other surface of the support member 200 facing the second surface 102 of the body 100.

In addition, the first coil portion 311 and the second coil portion 312 may be connected by a first via 321 penetrating the support member 200, and the sub lead-out portion 340 and the second lead-out portion 332 may be connected by a second via 322 penetrating the support member 200.

Referring to FIGS. 1, 2, 3 and 5, each of the first coil portion 311 and the second coil portion 312 may have at least one turn centered on the core 110. Each of the first coil portion 311 and the second coil portion 312 may have a flat spiral shape, but is not limited thereto.

The first coil portion 311 may be disposed on one surface of the support member 200 to form at least one turn centered on the core 110. The second coil portion 312 may be disposed on the other surface of the support member 200 to form at least one turn centered on the core 110.

Referring to FIGS. 2 and 5, the coil 300 may include a first via 321 connecting the first coil portion 311 disposed on one surface of the support member 200 and the second coil portion 312 disposed on the other surface of the first coil portion 311 to each other. The first via 321 may be disposed to penetrate the support member 200, but the present disclosure is not limited thereto.

The first via 321 may electrically connect the first and second coil portions 311 and 312 disposed on both surfaces of the support member 200. Specifically, based on the direction of FIG. 1, a lower surface of the first via 321 may be connected to an end of the innermost turn of the first coil portion 311, and an upper surface of the first via 321 may be connected to an end of the innermost turn of the second coil portion 312.

Referring to FIGS. 1 to 3, the coil 300 of the present embodiment may include a first lead-out portion 331 extending from an outermost turn of the first coil portion 311, and a sub lead-out portion 340 extending from an outermost turn of the second coil portion 312.

The first lead-out portion 331 may be disposed on one surface of the support member 200, extend from the outermost turn of the first coil portion 311, and be connected to a first external electrode 510 through a first connection portion 410 to be described later.

In addition, the sub lead-out portion 340 may be disposed on the other surface of the support member 200, extend from the end of the outermost turn of the second coil portion 312, and be connected to a second external electrode 520 through a second via 322 and a second connection portion 420, to be described later.

Referring to FIGS. 2 and 3, the second via 322 may connect the sub lead-out portion 340 and the second lead-out portion 332 to each other. Since the sub lead-out portion 340 and the second lead-out portion 332 are spaced apart from each other around the support member 200, the sub lead-out portion 340 and the second lead-out portion 332 may be connected to each other through the second via 322 penetrating the support member 200.

Here, the second via 322 may be formed integrally with the sub lead-out portion 340. Here, the second via 322 is formed integrally with the sub lead-out portion 340, which may mean that the second via 322 and the sub lead-out portion 340 are formed together in the same process and no boundary surface between the two components, but the present disclosure is not limited thereto.

Referring to FIGS. 2 and 3, for example, when a signal is input to the first external electrode 510, the input signal may be applied to the coil 300 through the first connection portion 410, and may be output to the second external electrode 520 through the second connection portion 420.

In more detail, a signal input to the first external electrode 510 may be output to the second external electrode 520 through the first connection portion 410, the first lead-out portion 331, the first coil portion 311, the first via 321, the second coil portion 312, the sub lead-out portion 340, the second via 322, and the second lead-out portion 332.

Thereby, the coil 300 may function as a whole as one coil between the first and second connection portions 410 and 420.

At least one of the first and second coil portions 311 and 312, the first and second vias 321 and 322, the first and second lead-out portions 331 and 332, and the sub lead-out portion 340 may include at least one conductive layer.

For example, when the first coil portion 311, the first via 321, the second lead-out portion 332, and the second via 322 are formed by plating on one surface of the support member 200, each of the first coil portion 311, the first via 321, the second lead-out portion 332, and the second via 322 may include a seed layer and an electroplating layer.

In this case, the electroplating layer may have a single-layer structure or a multilayer structure. The electroplating layer with a multilayer structure may be formed with a conformal film structure in which another electroplating layer is formed along a surface of one electroplating layer, and may also be formed in a shape in which another electroplating layer is laminated on only one surface of one electroplating layer. The seed layer may be formed by an electroless plating method or a vapor deposition method such as sputtering.

A seed layer of each of the first coil portion 311, the first via 321, the second lead-out portion 332, and the second via 322 may be formed integrally, so that no boundary is formed therebetween, but the present disclosure is not limited thereto. An electroplating layer of each of the first coil portion 311, the first via 321, the second lead-out portion 332, and the second via 322 may be formed integrally, so that no boundary is formed therebetween, but the present disclosure is not limited thereto.

Each of the first coil portion 311, the first via 321, the second lead-out portion 332, and the second via 322 may be formed of a conductive material such as copper (Cu), aluminum (Al), silver (Ag), tin (Sn), gold (Au), nickel (Ni), lead (Pb), titanium (Ti), alloys thereof, or the like, but the present disclosure is not limited thereto.

Referring to FIGS. 1 to 4, the coil component 1000 according to the present embodiment may include connection portions 410 and 420 connecting the first and second external electrodes 510 and 520 to the coil 300, respectively.

The connection portions 410 and 420 are disposed within the body 100 and are components for electrical connection between the coil 300 and the external electrodes 510 and 520, and as compared to L-type electrodes disposed on the third surface 103 and the fourth surface 104 of the body 100 and extending to the first surface 101, the connection portions 410 and 420 may have an effect of reducing direct resistance component (R_{dc}) as a path through which a current between the external electrodes 510 and 520 of the first surface 101 of the body 100 and the first surface 101 of the body 100 and the coil 300 is reduced.

The connection portions 410 and 420 may include one surface in contact with the coil 300 and the other surface in contact with the external electrodes 510 and 520.

In addition, the connection portions 410 and 420 may include a side surface connecting the one surface and the other surface, and may have a cylindrical shape. However, the present disclosure is not limited thereto, and the connection parts 410 and 420 may be formed in various shapes, such as a tapered shape of which a cross-sectional area becomes wider toward the bottom, a tapered shape of which a cross-sectional area becomes narrower toward the bottom, an angular pillar shape, or the like.

The connection portions 410 and 420 of the present embodiment may be formed by electroplating, and may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

In the coil component 1000 according to the present embodiment, the connection portions 410 and 420 connecting the external electrodes 510 and 520 in a first direction (T) may be formed separately from the coil 300, and then the coil 300 and the connection portions 410 and 420 may be fused.

Thereby, the connection portions 410 and 420 of the present embodiment may include fused portions 411 and 412 formed at ends thereof in contact with the coil 300. Here, the fused portions 411 and 412 may correspond to a region formed when the connection portions 410 and 420 and the coil 300 are fused by resistance welding, laser welding, ultrasonic welding, or the like, and for convenience of explanation, a boundary line thereof is indicated within the connection portions 410 and 420, by a dotted line.

Referring to FIG. 3, the first connection portion 410 may connect the first external electrode 510 and the first lead-out portion 331 within the body 100, and the first connection portion 410 may include a first fused portion 411 formed at an end, in contact with the first lead-out portion 331.

In addition, the second connection portion 420 may connect the first external electrode 520 and the first lead-out portion 332 within the body 100, and the second connection portion 420 may include a second fused portion 421 formed at an end, in contact with the second lead-out portion 332.

Meanwhile, the fused portions 411 and 412 of the present embodiment may have a partially deformed shape due to heat and pressure when fused to the coil 300 by resistance welding, laser welding, ultrasonic welding, or the like. This is explained in detail below.

FIG. 4 is an enlarged view of region A in FIG. 3 in which the second connection portion 420 and the second lead-out portion 332 are in contact.

Referring to FIGS. 3 and 4, the second connection portion 420 may include a second fused portion 421 formed in a region, in contact with the second lead-out portion 332, and at least a portion of the second fused portion 421 may be recessed into the second lead-out portion 332.

Likewise, the first connection portion 410 may include a first fused portion 411 formed in a region, in contact with the first lead-out portion 331, and at least a portion of the first fused portion 411 may be recessed into the first lead-out portion 331.

As an example, when the fused portions 411 and 421 and the lead-out portions 331 and 332 are fused through resistance welding, at least a portion of the fused portions 411 and 421 may be recessed into the lead-out portions 331 and 332 by heat generated according to a flow of current and pressure in the first direction (T).

Referring to FIG. 4, a portion of an upper surface of the second fused portion 421 may be expanded due to pressure in the first direction (T), and accordingly, at least a portion may protrude toward the body 100.

Likewise, the first fused portion 411 may also have at least a portion protruding toward the body 100.

Therefore, based on an optical microscope image or a scanning electron microscope (SEM) image of the first direction (T)-the second direction (L) cross-section taken from the central portion of the coil component 1000 in the third direction (W) according to the present embodiment as illustrated in FIG. 3, at least a portion of the fused portions 411 and 412 may protrude toward the body 100 in the second direction (L).

As an example, when the fused portions 411 and 421 and the lead-out portions 331 and 332 are fused through resistance welding, at least a portion of the fused portions 411 and 421 may protrude toward the body 100 by heat generated according to a flow of current and pressure in the first direction (T).

Referring to FIGS. 3 and 4, an interface may be formed between the fused portions 411 and 421 and the coil 300. In detail, an interface may be formed between the first fused portion 411 and the first lead-out portion 331, and an interface may be formed between the second fused portion 421 and the second lead-out portion 332.

Meanwhile, traces of metal particles being melted by heat so that a crystal structure has changed may be observed at the interface between the fused portions 411 and 421 and the lead-out portions 331 and 332.

In addition, unevenness US may be included in the interface between the fused portions 411 and 421 and the coil 300 of the present embodiment.

Referring to FIG. 4, irregular unevenness US may be included in the interface in which the second fused portion 421 contacts the second lead-out portion 332. For example, when the second fused portion 421 and the second lead-out portion 332 are fused through resistance welding, irregular unevenness US may be formed in the interface between the second fused portion 421 and the second lead-out portion 332 due to the heat generated according to a flow of current and pressure in the first direction (T).

In the coil component 1000 according to the present embodiment, a contact area between the fused portions 411 and 421 and the coil 300 may be increased due to the unevenness US described above, so that physical bonding force and electrical connection reliability may be increased, and a direct current resistance component (R_{dc}) may also be reduced.

Referring to FIGS. 3, 4 and 5, the coil component 1000 according to the present embodiment may further include an insulating film IF. The insulating film IF may integrally cover the support member 200 and the coil 300, and may extend to cover at least a portion of the connection portions 410 and 420.

Specifically, the insulating film IF may be disposed between the support member 200 and the body 100, between the coil 300 and the body 100, and between the connection portions 410 and 420 and the body 100. The insulating film IF may be formed along a surface of the support member 200 on which the coil portions 311 and 312, lead-out portions 331 and 332, and connection portions 410 and 420 are disposed, but the present disclosure is not limited thereto.

The insulating film IF may fill between adjacent turns of each of the first and second coil portions 311 and 312, and between each of the first and second lead-out portions 331 and 332 and the first and second coil portions 311 and 312 to insulate the coil turns.

The insulating film IF is to insulate between the coil 300 and the body 100 and/or between the connection portions 410 and 420 and the body 100, and may include a known insulating material such as parylene, but the present disclosure is not limited thereto. As another example, the insulating film IF may include an insulating material such as an epoxy resin rather than parylene. The insulating film IF may be formed by vapor deposition, but the present disclosure is not limited thereto. As another example, the insulating film IF may be formed by laminating and curing an insulating film on the support member 200 on which the coil 300 is disposed, and may also be formed by applying and curing an insulating paste on both surfaces of the support member 200 on which the coil 300 is disposed. Meanwhile, for the above-described reasons, the insulating film IF may be omitted in the present embodiment. That is, when the body 100 has sufficient electrical resistance at the designed operating current and voltage of the coil component 1000 according to the present embodiment, the insulating film IF may be omitted in the present embodiment.

Referring to FIGS. 1 to 3, the first and second external electrodes 510 and 520 may be disposed to be spaced apart from each other on the first surface 101 of the body 100 and respectively connected to the coil 300 through the first and second connection portions 410 and 420.

Referring to FIG. 3, the external electrodes 510 and 520 may be formed in a multi-layer structure.

For example, the external electrodes 510 and 520 may include first layers 511 and 521 disposed on the body 100, and second layers 512 and 522 disposed on the first layers 511 and 521. In addition, the external electrodes 510 and 520 may further include third layers 513 and 523 disposed on the second layers 512 and 522.

At least one of the second layers 512 and 522 and the third layers 513 and 523 may be formed to cover the first layers 511 and 521, but the scope of the present disclosure is not limited thereto.

The first layers 511 and 521 may be a copper (Cu) plating layer, or a conductive resin layer including conductive powder containing at least one of copper (Cu) and silver (Ag) and an insulating resin.

The second layers 521 and 522 may be plating layers containing nickel (Ni), and the third layers 513 and 523 may be plating layers containing tin (Sn), but the scope of the present disclosure is limited thereto. The second layers 512 and 522 and the third layers 513 and 523 may also be formed integrally in a form of an alloy of nickel (Ni) and tin (Sn).

The first and second external electrodes 510 and 520 may be formed by a vapor deposition method such as sputtering and/or a plating method, but the present disclosure is not limited thereto.

The first and second external electrodes 510 and 520 may be formed of a conductive material such as copper (Cu), aluminum (Al), silver (Ag), tin (Sn), gold (Au), nickel (Ni), lead (Pb), titanium (Ti), alloys thereof, or the like, but the present disclosure is not limited thereto.

Referring to FIGS. 3 and 5, the coil component 1000 according to the present embodiment may include insulating layers 610 and 620 covering the body 100 and exposing the external electrodes 510 and 520.

Specifically, the first insulating layer 610 of the present embodiment may cover at least a portion of the first surface 101 of the body 100, and may be disposed to expose the first and second external electrodes 510 and 520.

In addition, the second insulating layer 620 of the present embodiment may be disposed to cover at least a portion of the second to sixth surfaces 102, 103, 104, 105, and 106 of the body 100.

Referring to FIG. 3, both end surfaces of the first insulating layer 610 may abut on inner side surfaces of the first layers 511 and 521 in the second direction (L).

In this embodiment, the second layers 512 and 522 may overlap portions of the first insulating layer 610 in the first direction (T), and may cover outer side surfaces of the first layers 511 and 521, respectively, in the second direction (L).

Referring to FIG. 5, the first and second insulating layers 610 and 620 of the present embodiment may be formed in different processes to form a boundary therebetween, and in the second insulating layer 620, respective insulating layers disposed on the second to sixth surfaces 102, 103, 104, 105, and 106 of the body 100 may be disposed in the same process to be integrally formed without no boundary, but the scope of the present disclosure is not limited thereto.

The first and second insulating layers 610 and 620 may be formed by a method such as printing, vapor deposition, spray coating, or film lamination, but the present disclosure is not limited thereto.

The first and second insulating layers 610 and 620 may include a thermoplastic resin such as polystyrene-based, vinyl acetate-based, polyester-based, polyethylene-based, polypropylene-based, polyamide-based, rubber-based, acrylic-based, and the like, a thermosetting resin such as phenol-based, epoxy-based, urethane-based, melamine-based, alkyd-based resins, and the like, a photosensitive insulating resin, parylene, SiOₓ, or SiNₓ. The first and second insulating layers 610 and 620 may further include an insulating filler such as an inorganic filler, but the present disclosure is not limited thereto.

### Manufacturing Process of Coil Component According to First Embodiment

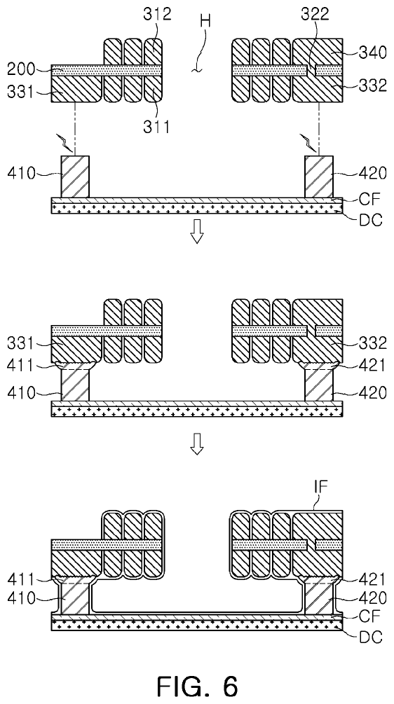

FIGS. 6, 7 and 8 are diagrams schematically illustrating a manufacturing process of the coil component 1000 according to a first embodiment of the present disclosure.

Referring to FIG. 6, a through-hole H in which a core 110 is to be disposed and a via hole in which vias 321 and 322 are to be disposed may be formed in the support member 200, and first and second coil portions 311 and 312, first and second vias 321 and 322, first and second lead-out portions 331 and 332, and a sub lead-out portion 340 may be disposed by plating.

Next, a detach core DC in which a copper foil CF is disposed on one surface may be prepared, and connection portions 410 and 420 may be formed by copper (Cu) plating on an upper surface of the copper foil CF.

Next, the lead-out portions 331 and 332 and the connection portions 410 and 420 may be fused using resistance welding, laser welding, ultrasonic welding, or the like.

Fused portions 411 and 421, which are partially deformed due to heat and pressure, may be formed in upper regions of the connection portions 410 and 420 in contact with the lead-out portions 331 and 332.

Next, an insulating film IF may be formed to integrally cover the coil 300 and the connection portions 410 and 420. The insulating film IF of the present disclosure may include parylene, but the present disclosure is not limited thereto. Meanwhile, a non-adhesive parylene insulating film IF may be formed on the copper foil CF, and then there is an advantage that a separation process becomes easier when separating the detach core DC from the body 100.

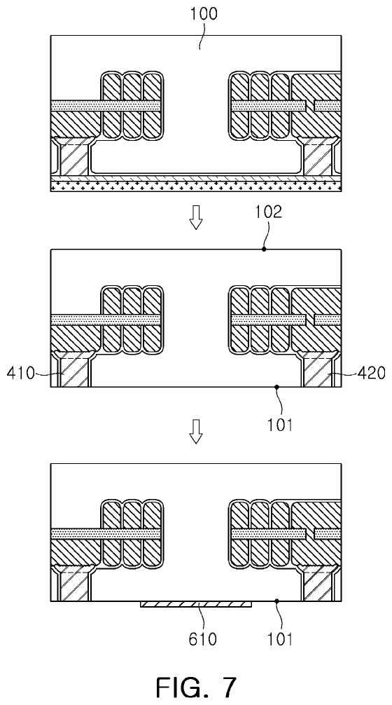

Next, referring to FIG. 7, a body 100 may be formed by stacking and curing magnetic sheets with the coil 300, the connection portions 410 and 420, and the detach core DC connected.

Next, the detach core DC containing the copper foil CF may be removed to expose the first surface 101 of the body 100 and the other surface of the connection portions 410 and 420. In this case, a portion of the insulating film IF having no bonding strength with the body 100 may also be removed from the first surface 101 of the body 100.

Next, the first insulating layer 610 may be disposed on the remaining region of the first surface 101 of the body 100, except for the region in which the external electrodes 510 and 520 are to be disposed. The first insulating layer 610 may be formed using a screen printing method, but the present disclosure is not limited thereto.

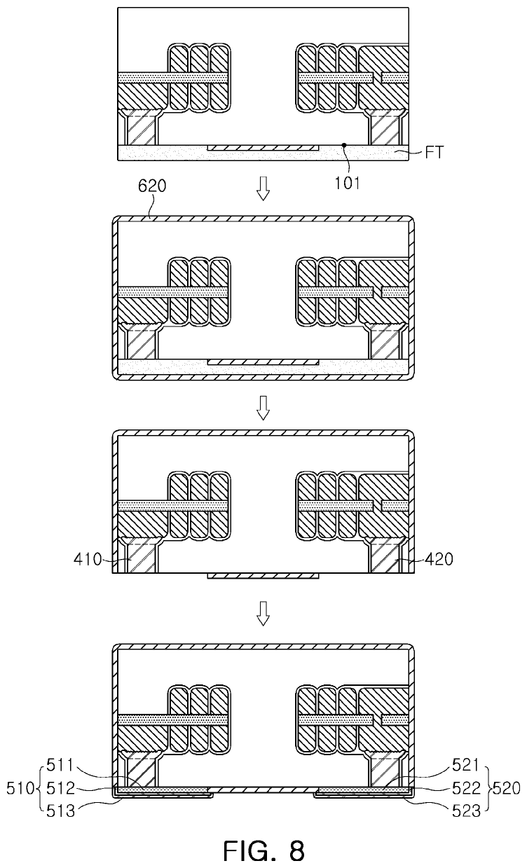

Referring to FIG. 8, a foam tape FT may be disposed on the first surface 101 of the body 100 to cover the first insulating layer 610.

Meanwhile, the foam tape FT is a component to facilitate batch printing and partial removal of the second insulating layer 620.

Next, a second insulating layer 620 may be disposed to integrally cover the second to sixth surfaces 102, 103, 104, 105, and 106 of the body 100 and the foam tape FT. The second insulating layer 620 may be formed by drum coating, but the present disclosure is not limited thereto.

Next, by foaming and removing the foam tape FT, only a region in which the external electrodes 510 and 520 are to be disposed among the outer surfaces of the body 100 may be exposed.

Finally, the first layers 511 and 521, the second layer 512 and 522, and the third layers 513 and 523 of the external electrodes 510 and 520 may be sequentially formed by plating, so that the external electrodes 510 and 520 may be disposed.

### Second Embodiment

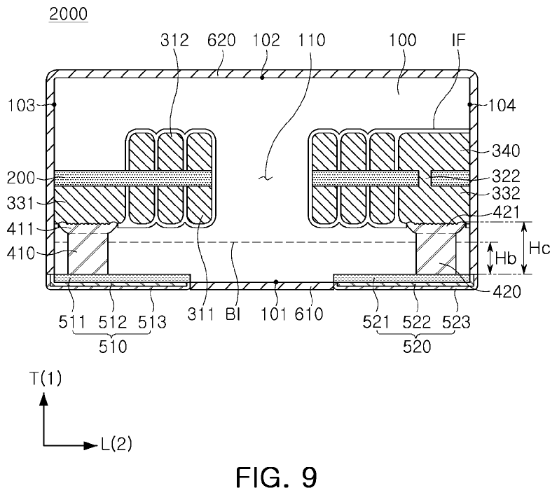

FIG. 9 is a diagram corresponding to FIG. 3 schematically illustrating a coil component 2000 according to a second embodiment of the present disclosure.

Comparing FIG. 9 with FIG. 3, FIG. 9 is different from FIG. 3 in that a body interface BI, perpendicular to the first direction T is formed inside the body 100, an insulating film IF is partially open and does not cover the connection portions 410 and 420, and the first layers 511 and 521 of the external electrodes 510 and 520 are buried inside the body 100.

Therefore, in describing the present embodiment, only a structure in which a portion of the body interface BI and the insulating film IF are open and a structure in which the first layers 511 and 521 of the external electrodes 510 and 520 are buried inside the body 100, which are different from that of the first embodiment, will be described. As for the remaining components of the present embodiment, the description in the first embodiment of the present invention may be applied as is.

Referring to FIG. 9, the coil component 2000 according to a second embodiment of the present disclosure may include a body interface BI, formed inside the body 100 and perpendicular to the first direction (T).

The body interface BI may be formed to be lower than one surface of the connection portions 410 and 420. That is, based on the inner surfaces of the external electrodes 510 and 520, a height Hb of the body interface BI may be formed to be lower than a height Hc thereof to upper surfaces of the connection portions 410 and 420.

In this case, based on the optical microscope image or Scanning Electron Microscope (SEM) image of the length direction (L)-width direction (W) cross-section taken from a central portion of the coil component 1000 in the width direction (W), the height Hb of the body interface BI may refer to an arithmetic average value of at least three of respective dimensions of a plurality of line segments connecting the body interface BI illustrated in the cross-sectional image and innermost surfaces of the external electrodes, to be parallel to each other. In this case, the plurality of line segments parallel to the thickness direction (T) may be equally spaced from each other in the length direction (L), but the scope of the present disclosure is not limited thereto.

In addition, the height Hc to the upper surfaces of the connection portions 410 and 420 may refer to an arithmetic average value of at least three of respective dimensions of a plurality of line segments, obtained by setting an interface in which the connection portions 410 and 420 illustrated in the cross-sectional image and the coil 300 are in contact as a center line, and connecting the center line and the innermost surfaces of the external electrodes 510 and 520 in the thickness direction (T), to be parallel to each other. In this case, the plurality of line segments parallel to the thickness direction (T) may be equally spaced from each other in the length direction (L), but the scope of the present disclosure is not limited thereto.

The body interface BI of the present embodiment may be formed in the region between the coil 300 and the first surface 101, and may correspond to a feature resulting from the fact that the process for forming the body 100 is performed in two stages. The detailed process sequence is described later.

Referring to FIG. 9, since the connection portions 410 and 420 of the present embodiment are not covered by the insulating film IF, a side surface thereof connecting the upper and lower surfaces of the connection portions 410 and 420 may be in direct contact with the body 100. In the present embodiment, it is preferable that the magnetic metal powder included in the body 100 is insulated and coated.

In the coil component 2000 according to the present embodiment, the insulating film IF may be partially open to expose at least a portion of the fused portions 411 and 421 from an inside of the body 100.

The external electrodes 510 and 520 of the present embodiment may be disposed so that the first layers 511 and 521 are in contact with the lower surfaces of the connecting portions 410 and 420 and are buried in the body 100.

Specifically, the first layers 511 and 521 of the present embodiment may have an inner surface in contact with the body 100 and an outer surface facing the inner surface, and the outer surface may be disposed not to protrude beyond the first surface 101 of the body 100. That is, the outer surfaces of the first layers 511 and 521 of the external electrodes 510 and 520 may be formed inwardly or at the same level as the first surface 101 of the body 100.

Therefore, the coil component 2000 according to the present embodiment may have a shape in which the outermost surfaces of the external electrodes 510 and 520 do not protrude beyond the first insulating layer 610.

In this embodiment, the third layers 513 and 523 of the external electrodes 510 and 520 may cover inner side surfaces of the second layers 512 and 522 in the second direction (L).

In addition, both end surfaces of the first insulating layer 610 may abut on inner side surfaces of the third layers 513 and 523, respectively, in the second direction (L).

As compared to the first embodiment, in the coil component 2000 according to the present disclosure, since a magnetic material may be filled in a region secured by removing the insulating film IF within the body 100, and some regions of the external electrodes 510 and 520 may be buried in the body 100, a larger effective volume may be secured within a limited size, inductance characteristics may be improved.

### Manufacturing Process of Coil Component According to Second Embodiment

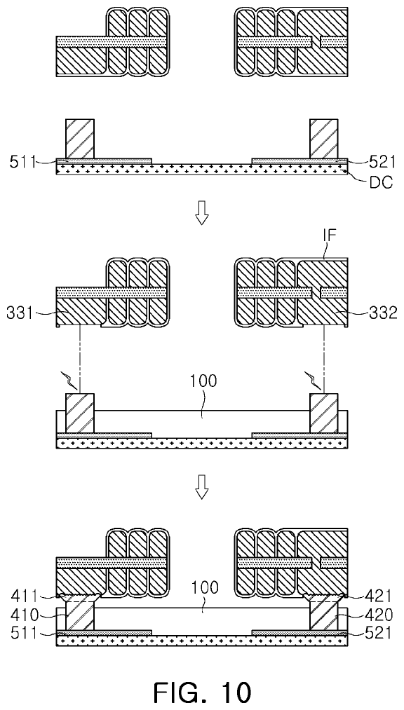

FIGS. 10, 11 and 12 are views schematically illustrating a manufacturing process of a coil component according to a second embodiment of the present disclosure.

The reference numerals of the components illustrated in FIGS. 10, 11 and 12 are the same as those in FIGS. 6, 7 and 8, and some reference numerals are omitted for ease of understanding.

Referring to FIG. 10, a through-hole H in which a core 110 is to be disposed and a via hole in which vias 321 and 322 are to be disposed may be formed on a support member 200, and first and second coil portions 311 and 312, first and second vias 321 and 322, first and second lead-out portions 331 and 332, and a sub lead-out portion 340 may be disposed by plating.

An insulating film IF may be formed to integrally cover the coil 300 and the support member 200.

Next, first layers 511 and 521 of external electrodes 510 and 520 may be formed in advance by partially removing a copper foil CF on a detach core DC, and connection portions 410 and 420 may be formed on the first layers 511 and 521 by copper (Cu) plating.

Next, a region of the insulating film IF integrally covering the coil 300 and the support member 200 to be connected to the connection portions 410 and 420 may be removed in advance and a portion of regions of lower surfaces of the first lead-out portion 311 and the second lead-out portion 332 may be exposed.

Next, a portion of the body 100 may be formed by stacking and curing magnetic sheets on the first layers 511 and 521 and the connecting portions 410 and 510 disposed on the detach core DC.

Thereby, the first layers 511 and 521 of the external electrodes 510 and 520 of the present embodiment may be buried in the body 100.

A height of the body 100 formed at this time may correspond to a height of a body interface BI of the coil component 2000 of the present embodiment, and may be formed on a level, lower than that of upper surfaces of the connection portions 410 and 420.

Meanwhile, in the present embodiment, when a sheet with the connection portions 410 and 420 punched out is used as a magnetic sheet for forming a portion of the body 100, deformation of the connection portions 410 and 420 may be prevented when the magnetic sheet is pressed.

Next, the lead-out portions 331 and 332 and the connection portions 410 and 420 may be fused using resistance welding, laser welding, ultrasonic welding, or the like.

Fused portions 411 and 421, which are partially deformed due to heat and pressure, may be formed in upper regions of the connection portions 410 and 420 in contact with the lead-out portions 331 and 332.

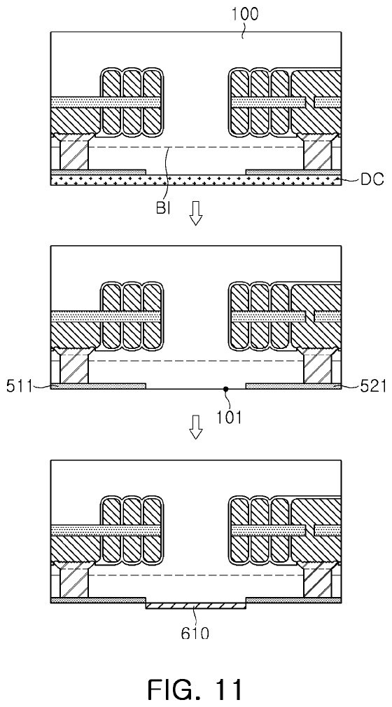

Referring to FIG. 11, a magnetic sheet may be stacked and cured on the remaining region of a body 100 from top to bottom with the coil 300, the connection portions 410 and 420, and the detach core DC connected, thereby completing the body 100.

In this case, a body interface BI may be formed between some regions of the body 100 formed earlier in FIG. 10 and the remaining region of the body 100 formed later in FIG. 11.

Next, the detach core DC may be removed to expose the first surface 101 of the body 100 and the first layers 511 and 521 of the external electrodes 510 and 520.

Next, a first insulating layer 610 may be disposed in a region of the first surface 101 of the body 100, except for a region in which the first layers 511 and 521 of the external electrodes 510 and 520 are disposed. The first insulating layer 610 may be formed using a screen printing method, but the present disclosure is not limited thereto.

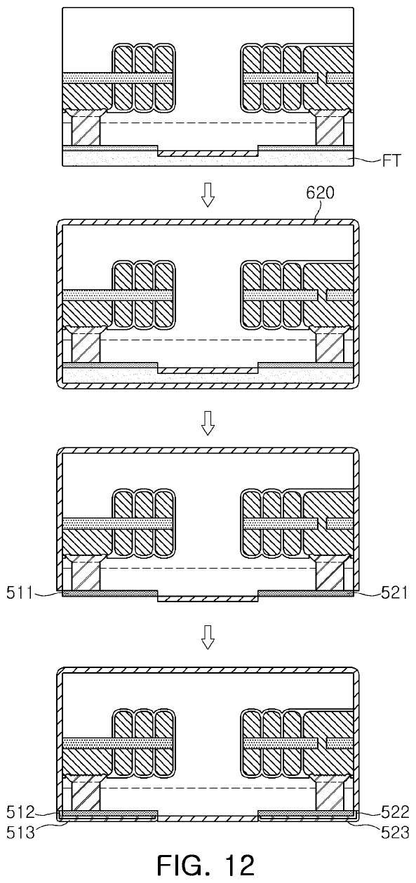

Referring to FIG. 12, a foam tape (FT) may be disposed to cover the first insulating layer 610 and the first layers 511 and 521 of the external electrodes 510 and 520 on the first surface 101 of the body 100.

Meanwhile, the foam tape FT is configured to facilitate batch printing and partial removal of the second insulating layer 620.

Next, the second insulating layer 620 may be disposed to integrally cover the second to sixth surfaces 102, 103, 104, 105, and 106 of the body 100 and the foam tape FT. The second insulating layer 620 may be formed by drum coating, but the present disclosure is not limited thereto.

Next, by foaming and removing the foam tape FT, only a region in which the first layers 511 and 521 of the external electrodes 510 and 520 are disposed among the outer surfaces of the body 100 may be exposed.

Finally, second layers 512 and 522 and third layers 513 and 523 may be sequentially formed by plating on the first layers 511 and 521, thereby completing the external electrodes 510 and 520.

As set forth above, according to embodiments of the present disclosure, inductance characteristics and saturated current (Iₛₐₜ) characteristics may be improved by maximizing an effective volume within a coil component of a limited size through a structure in which a coil and an external electrode are connected inside a body.

According to embodiments of the present disclosure, through a process of forming a connection portion formed by connecting a coil and an external electrode and the external electrode in advance and then bonding the same to the coil, process advantages such as preventing defective connection between the coil and external electrode, preventing plating defects of the external electrode from spreading, or the like may be obtained.

While example embodiments have been illustrated and described above. it will be apparent to those skilled in the art that modifications and variations could be made without departing from the scope of the present disclosure as defined by the appended claims.

What is claimed is:

1. A coil component, comprising:
a body having a first surface and a second surface facing each other in a first direction;
a support member disposed within the body;
a coil disposed on the support member;
an external electrode disposed on the first surface of the body; and
a connection portion disposed within the body to connect the coil and the external electrode, the connection portion having one surface in contact with the coil and another surface in contact with the external electrode,
wherein the connection portion includes a fused portion formed at an end in contact with the coil.

2. The coil component of claim 1, wherein at least a portion of the fused portion protrudes toward the coil.

3. The coil component of claim 1, wherein at least a portion of the fused portion protrudes toward the body.

4. The coil component of claim 1, wherein an interface is formed between the fused portion and the coil.

5. The coil component of claim 4, wherein the interface comprises unevenness.

6. The coil component of claim 1, further comprising:
an insulating film covering the coil.

7. The coil component of claim 6, wherein the insulating film extends to cover at least a portion of the connection portion.

8. The coil component of claim 6, wherein the connection portion comprises a side surface connecting the one surface and the other surface of the connection portion, and
the side surface of the connection portion is in contact with the body.

9. The coil component of claim 6, wherein the insulating film exposes at least a portion of the fused portion.

10. The coil component of claim 8, wherein the body comprises a body interface perpendicular to the first direction.

11. The coil component of claim 10, wherein the body interface is located at a lower level than the one surface of the connection portion.

12. The coil component of claim 1, wherein the external electrode comprises a first layer disposed on the body and a second layer disposed on the first layer.

13. The coil component of claim 12, wherein the external electrode further comprises
a third layer disposed on the second layer.

14. The coil component of claim 12, wherein the first layer is in contact with the other surface of the connection portion and is buried in the body.

15. The coil component of claim 12, wherein the first layer has an inner surface in contact with the body and an outer surface opposing the inner surface, and
the outer surface of the first layer does not protrude beyond the first surface of the body.

16. The coil component of claim 1, further comprising:
a first insulating layer covering the first surface of the body, and exposing the external electrode.

17. The coil component of claim 16, further comprising:
a second insulating layer covering remaining surfaces of the body except for the first surface of the body.

18. The coil component of claim 16, wherein the external electrode comprises a first layer disposed on the body and a second layer disposed on the first layer, and
an end surface of the first insulating layer abuts on an inner side surface of the first layer of the external electrode in a second direction perpendicular to the first direction.

19. The coil component of claim 18, wherein the second layer of the external electrode overlaps a portion of the first insulating layer in the first direction, and covers an outer side surface of the first layer of the external electrode in the second direction.

20. The coil component of claim 16, wherein the external electrode comprises a first layer disposed on the body, a second layer disposed on the first layer, and a third layer disposed on the second layer,
the third layer of the external electrode covers an inner side surface of the second layer in a second direction perpendicular to the first direction, and
an end surface of the first insulating layer abuts on an inner side surface of the third layer in the second direction.
